(19) United States
(12) Patent Application Publication
(10) Pub. No.: US 2013/0307857 A1
(43) Pub. Date: Nov. 21, 2013

(54) USING A PIEZO-ELECTRIC LAYER TO MITIGATE STICTION OF A MOVABLE ELEMENT

(71) Applicants: Koorosh Aflatooni, Cupertino, CA (US); Igor Tchertkov, Pleasanton, CA (US)

(72) Inventors: Koorosh Aflatooni, Cupertino, CA (US); Igor Tchertkov, Pleasanton, CA (US)

(73) Assignee: QUALCOMM MEMS Technologies, Inc., San Diego, CA (US)

(21) Appl. No.: 13/474,129

(22) Filed: May 17, 2012

(51) Int. Cl. G02F 1/29; G06T 1/00; G02B 26/08

(52) U.S. Cl. 345/501; 359/315

(57) ABSTRACT

This disclosure provides systems, methods and apparatus for mitigating or reducing stiction in electromechanical systems devices. The systems and methods described herein include a piezo-electric layer disposed over at least a portion of the deformable region of the electromechanical systems devices. To reduce or mitigate stiction, a restorative mechanical force is generated by reverse piezo-electric effect to return the deformable region of the electromechanical systems devices to the un-deformed state.

### TECHNICAL FIELD

This disclosure relates to piezo-electric layers and more particularly to piezo-electric layers that can mitigate stiction in electromechanical systems.

### DESCRIPTION OF THE RELATED TECHNOLOGY

Electromechanical systems include devices having electrical and mechanical elements, actuators, transducers, sensors, optical components (for example, mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Various surfaces of the electromechanical systems (for example, a surface of the reflective membrane) can unintentionally adhere when mechanical restoring forces are unable to overcome surface adhesion forces such as capillary and electrostatic, van der Waals forces, the Casimir effect, and other kinds of attraction forces. This unintentional adhesion is referred to as “stiction.” Stiction in electromechanical systems can be of two types: (i) release related stiction; and (ii) in-use stiction. Release related stiction occurs during the process of “release” of the layers (for example, sacrificial layer removal) during fabrication of the electromechanical system. Surfaces of released electromechanical systems can adhere together upon contact during operation of the electromechanical system, and such adhesion can be referred to as “in-use stiction.” Various engineering methods such as surface engineering and surface coating have been proposed to reduce stiction in electromechanical systems.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical systems device, comprising an optical stack, a movable layer, and a piezo-electric layer. The movable layer is disposed over the optical stack and separated from the optical stack by a gap. The movable layer includes a deformable region that deforms when the movable layer is actuated. The movable layer further includes an optically active region that is positioned substantially flat when the movable layer is actuated. The movable layer is configured to actuate between at least a first position that is farther from the optical stack and a second position that is closer to the optical stack by the application of a first voltage across the optical stack and the movable layer. The deformable region of the movable layer is in an un-deformed state in the first position and in a deformed state in the second position. The piezo-electric layer is disposed over at least a portion of the deformable region of the movable layer. The piezoelectric layer is configured to provide a restorative force to restore the movable layer from the second position to the first position upon application of a second voltage across a first electrical contact and a second electrical contact of the piezoelectric layer.

In various implementations of the electromechanical systems device, the movable layer can include a first electrode layer that includes the first electrical contact. The electromechanical systems device can include a second electrode layer that includes the second electrical contact. In various implementations, the piezo-electric layer can be disposed between the movable layer and the second electrode. In various implementations, the first electrode layer can include a first portion including the first electrode contact and a second portion that includes the second electrical contact. In such implementations, the piezo-electric layer can extend between the first and second electrical contacts of the first electrode layer. In various implementations, the second voltage can be applied across the first and second electrode layers. In various implementations, the second voltage can be applied across the first and second electrical contacts of the first electrode layer.

In various implementations, the piezo-electric layer is configured such that a magnitude of the restorative force depends at least in part on the magnitude and/or the polarity of the second voltage. In various implementations, the magnitude of the second voltage can be between 0V and 40V. The second voltage can be an alternating current (AC) signal. In various implementations, a frequency of the AC signal can be proportional to the resonance frequency of the movable layer and/or the piezo-electric layer. In various implementations, the first electrical contact can be connected to an electrical ground via a first electrical switch and the second electrical contact can be connected to the electrical ground via a second electrical switch. In various implementations, the first and the second electrical switches can be periodically toggled to provide the restorative force. In various implementations, the first and the second electrical contacts can be connected together via an electrical switch which can be periodically toggled to short the first and second electrical contacts to provide the restorative force.

In various implementations, the movable layer can include a partially reflective layer. In various implementations, the movable layer, the optical stack and the gap can form an interferometric modulator. In various implementations, the device can be a reflective display element. In various implementations, the device can include at least one support structure that is configured to support the movable layer over the optical stack. The non-deformable region of the movable layer can be disposed over the support structure.

Another innovative aspect of the subject matter described in this disclosure can be implemented in an electromechanical systems device comprising means for partially transmitting light, a movable means for reflecting light and a means for producing mechanical strain. The movable light reflecting means is disposed over the partially light transmitting means and separated from the partially light transmitting means by a gap. The movable light reflecting means includes a deformable region that deforms when the movable light reflecting means is actuated. The movable light reflecting means includes an optically active region that is substantially flat when the movable light reflecting means is actuated. The movable light reflecting means is configured to actuate between at least a first position that is farther from the partially light transmitting means and a second position that is closer to the partially light transmitting means by the application of a first voltage between the partially light transmitting means and the movable reflecting means. The deformable region of the movable reflecting means is in an un-deformed state in the first position and in a deformed state in the second position. The mechanical strain producing means is disposed over at least a part of the deformable region of the movable light reflecting means. The mechanical strain producing means is configured to generate a mechanical restorative force to restore the movable light reflecting means from the second position to the first position upon application of a second voltage across a first electrical contact and a second electrical contact of the mechanical strain producing means.

In various implementations of the device, the fixed means for partially transmitting light can include an optical stack having a partially transmissive layer. In various implementations, the movable means for reflecting light can include a movable reflecting layer. In various implementations, the mechanical strain producing means can include a piezo-electric layer. In various implementations, the movable means for reflecting light can include a first electrode layer that includes the first electrical contact. Various implementations of the device can further include a second electrode layer such that the mechanical strain producing means is disposed between the movable light reflecting means and the second electrode. In various implementations of the device, the first electrode layer can include a first portion including the first electrical contact and a second portion including the second electrical contact, and the mechanical strain producing means can extend between the first and second portions of the first electrode layer.

Another innovative aspect of the subject matter described in this disclosure can be implemented in a method of manufacturing an electromechanical systems device. The method includes providing a substrate. The method further includes forming a stack that is partially transmissive to light over the substrate. The method further includes forming a movable layer over the stack. The movable layer is separated from the stack by a gap. Forming the movable layer includes forming a deformable region that deforms when the movable layer is actuated and forming an optically active region that is positioned substantially flat when the movable layer is actuated. The movable layer is configured to actuate between at least a first position that is farther from the fixed stack and a second position that is closer to the fixed stack by the application of a first voltage between the fixed stack and the movable layer. The deformable region of the movable layer is in an un-deformed state in the first position and in a deformed state in the second position. The method further includes forming a piezo-electric layer over at least part of the deformable region of the movable layer. The piezoelectric layer is configured to provide a restorative mechanical force to restore the movable layer from the second position to the first position upon application of a second voltage across a first electrical contact and a second electrical contact of the piezoelectric layer.

In various implementations of the method, forming the movable layer can include forming a first electrode that includes the first electrical contact. In various implementations, forming the first electrode can include patterning the first electrode to have a first portion and a second portion. The first and second portions can be separated from each other by an opening. The piezo-electric layer can be formed such that a portion of the piezo-electric layer extends into the opening. The method can further include forming a second electrode layer over the piezo-electric layer.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A-9C show various implementations of an electromechanical systems device that includes a plurality of layers and a piezo-electric layer.

FIG. 9D illustrates a top-view of the implementation of an electromechanical systems device including a piezo-electric layer as depicted in FIG. 9C.

FIG. 9E is an enlarged view of the piezo-electric layer illustrated in FIG. 9C.

FIG. 10A shows the charges accumulated in an example implementation of a piezo-electric layer sandwiched between two electrodes as depicted in FIG. 9B.

FIG. 10B shows the charges accumulated in an example implementation of a piezo-electric layer disposed over two electrodes as depicted in FIG. 9C.

FIGS. 11A-11C is a schematic top view of an example of an array of electromechanical systems devices each including a piezo-electric layer and including different methods of providing an additional restorative mechanical force to return the piezo-electric layer to the un-deformed state.

FIG. 12 shows an example of a timing diagram for voltages applied to the example depicted in FIG. 11C.

FIG. 13 is a flowchart showing an example of a method of manufacturing an implementation of an electromechanical systems device including a piezo-electric layer.

FIGS. 14A and 14B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (for example, video) or stationary (for example, still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (for example, odometer display, etc.), cockpit controls and/or displays, camera view displays (for example, display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (for example, MEMS and non-MEMS), aesthetic structures (for example, display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

The electromechanical systems devices can include an array of interferometric modulators (IMODs). An interferometric modulator referred to herein can be configured as a bi-stable electromechanical device or an analog electromechanical device (sometimes referred to specifically as an “AIMOD”). Implementations of IMODs described herein can include an optical stack that is at least partially transmissive to light in the visible spectral range, a movable layer and a piezo-electric layer both disposed over the optical stack. The movable layer includes an optically active region that is at least partially reflective to light in the visible spectral range. The optically active portion of the movable layer includes a deformable region that can be actuated between a first position that is further from the optical stack and a second position that is closer to the optical stack by the application of an actuating force. The movable layer is in an un-deformed state in the first position and in a deformed state in the second position. The piezo-electric layer is disposed over at least a portion of the deformable region of the movable layer. The piezo-electric layer provides a restorative electro-mechanical force upon the application of a voltage across the piezo-electric layer that can restore the deformable region of the movable layer to the un-deformed state in the absence of the actuation force. The voltage applied across the piezo-electric layer can be a pulse of alternating current (AC) voltage. The frequency of the AC voltage pulse can be proportional to a resonance frequency of the movable layer.

Particular implementations of the subject matter described in this disclosure can be implemented to realize one or more of the following potential advantages. Disposing a piezo-electric layer over at least a portion of the deformable region of the movable layer in various implementations of IMODs can reduce or mitigate release related stiction of the movable layer during the fabrication of the IMODs which can advantageously increase yield of the IMODs. Additionally, the piezo-electric layer disposed over at least a portion of the deformable region of the movable layer can reduce or mitigate stiction of the movable layer during operation of the IMODs, which can increase the lifetime and/or the performance of devices including such implementations of IMODs.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, that is, by changing the position of the reflector.

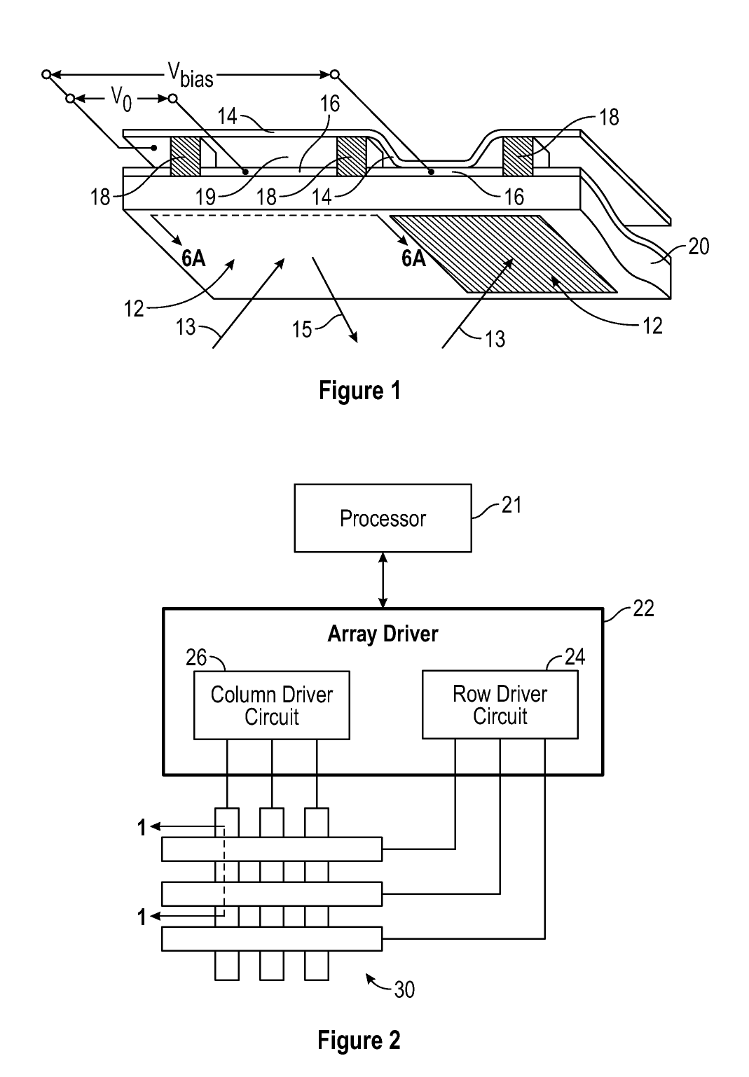

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (for example, of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

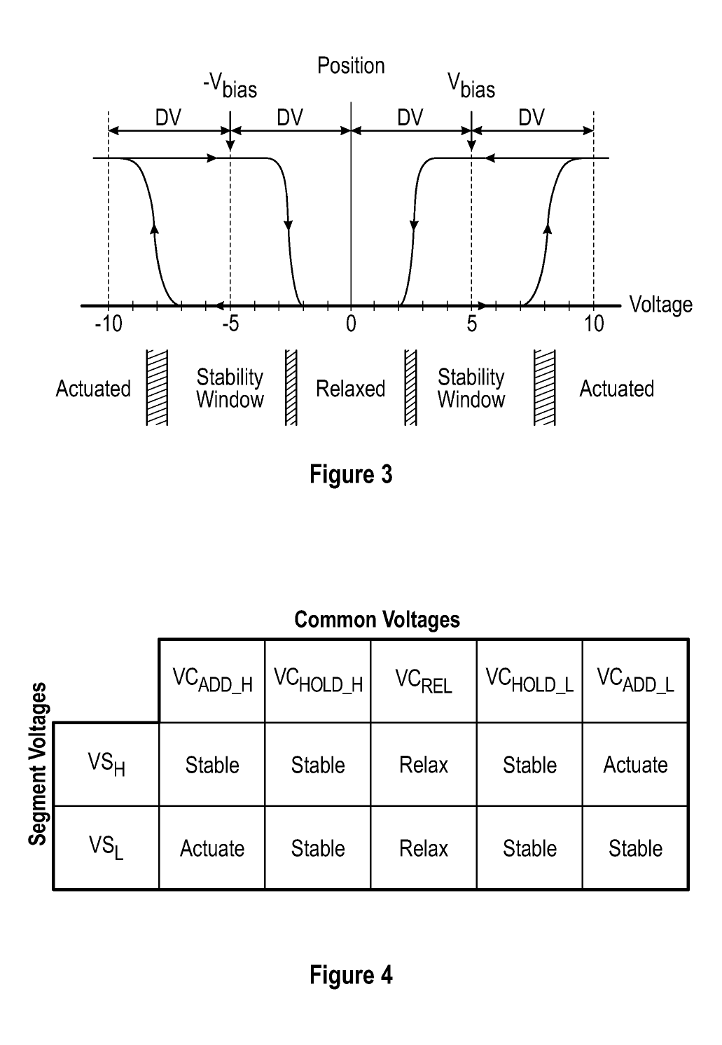

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

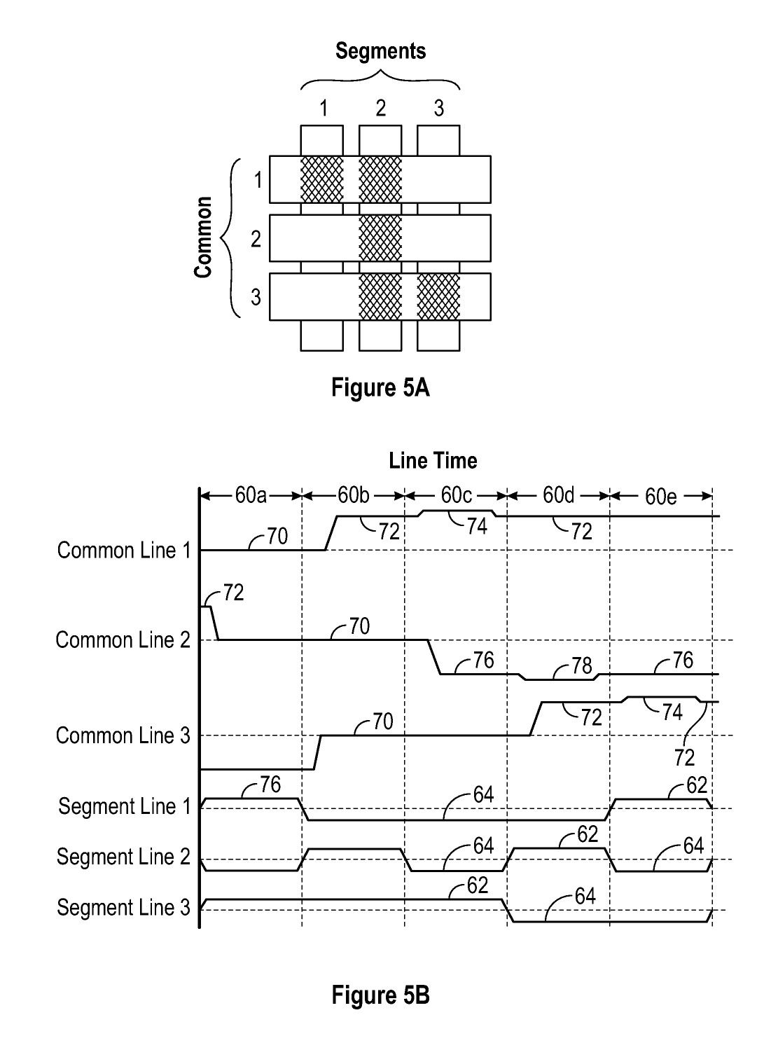

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

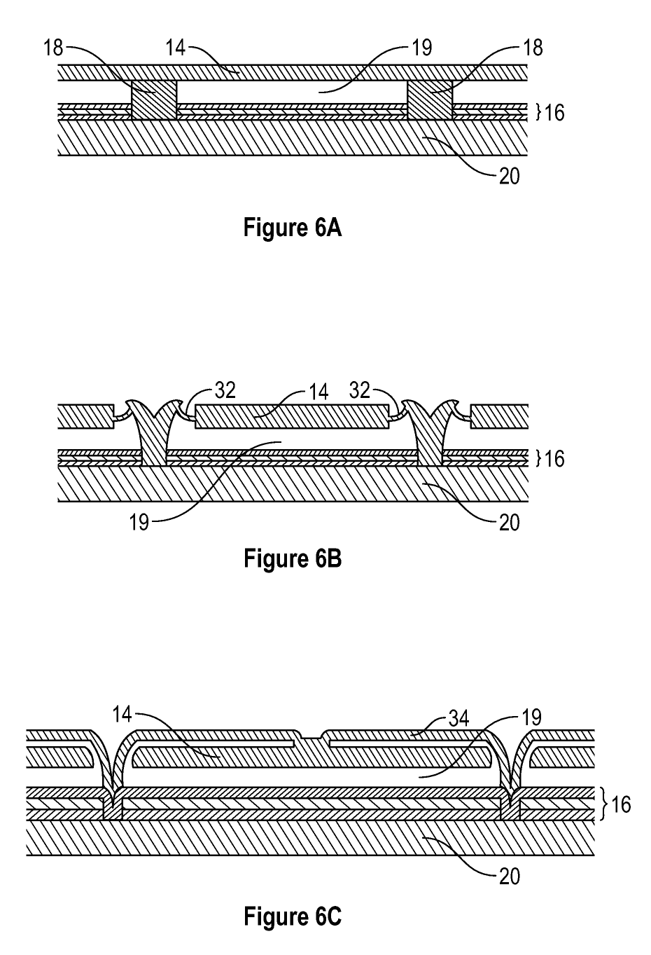

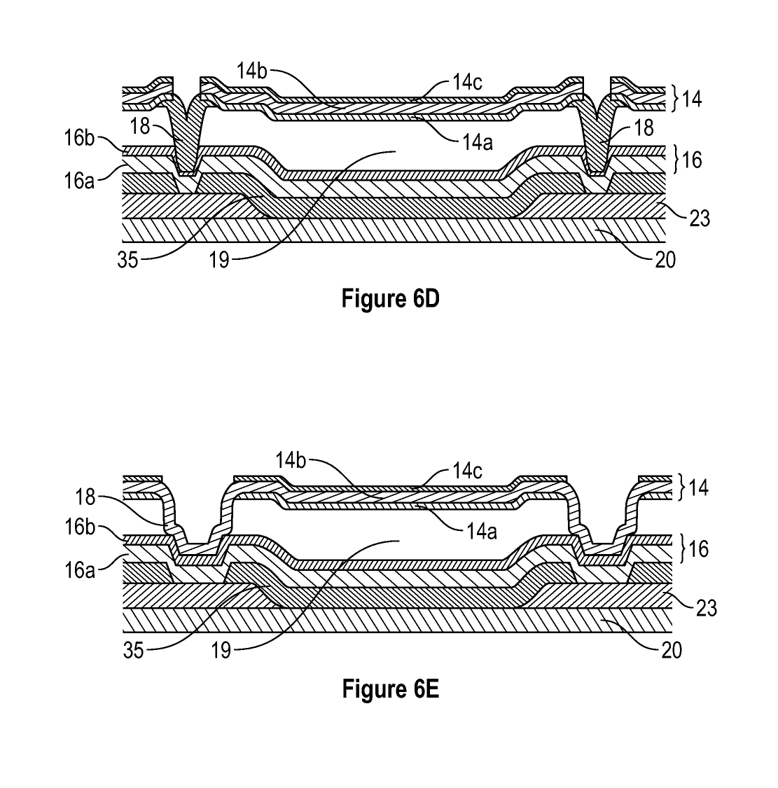

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

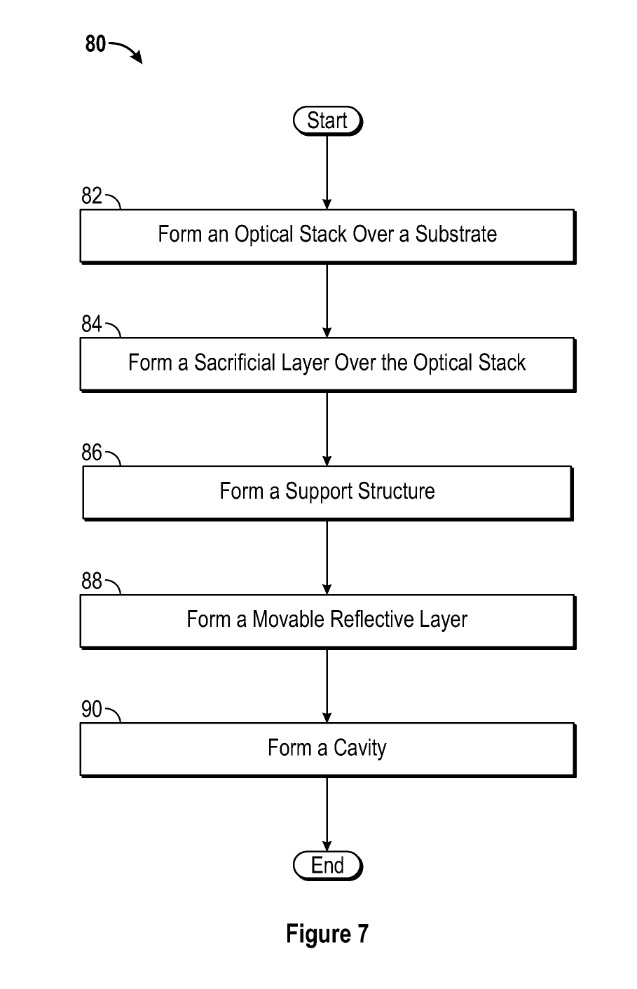

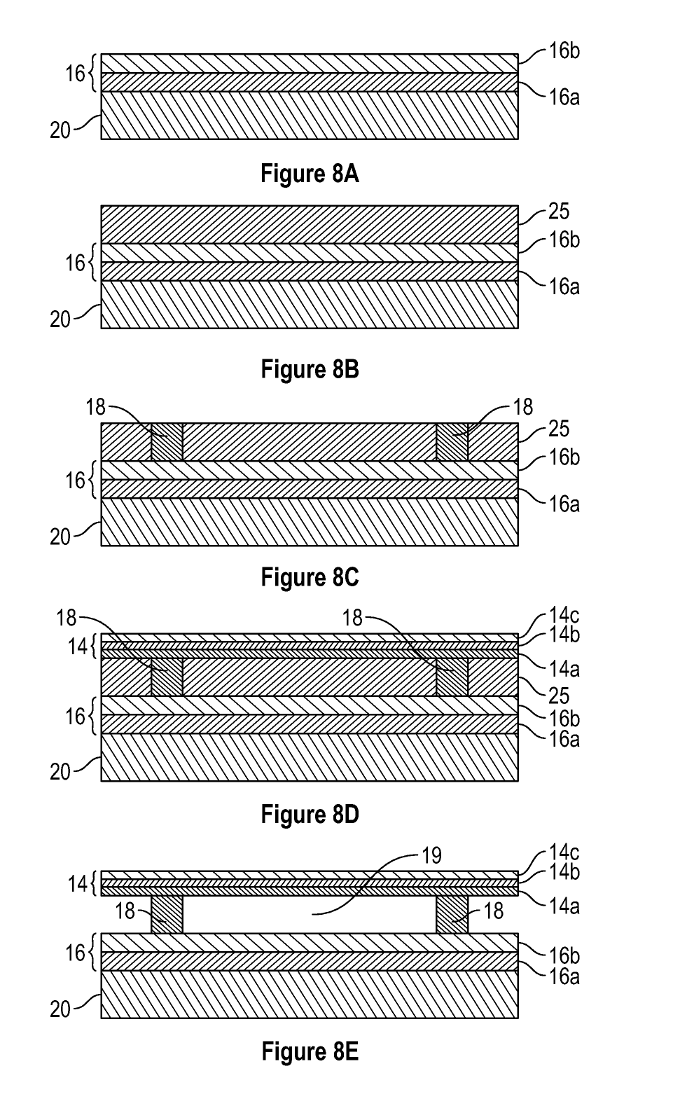

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

In various implementations of electromechanical systems (for example, the IMOD 12 illustrated in FIG. 1), a surface of a movable layer (for example, the movable reflective layer 14) may adhere to a surface of other fixed layers of the electromechanical systems (for example, the optical stack 16) during fabrication or over time when the inter-surface forces (e.g., force due to surface adhesion) between the surface of the movable layer and the surface of the other fixed layers become greater than the mechanical restorative force of the movable layer. In some implementations, a reduction in the mechanical restorative force can be related to weakening of the spring-like behavior of the movable layer. Thus, systems and methods that can mitigate stiction of the movable layer are desirable to increase the yield, lifetime and performance of the electromechanical systems. In various implementations described herein, a piezo-electric layer is provided to the electromechanical systems to increase the restorative force and reduce stiction.

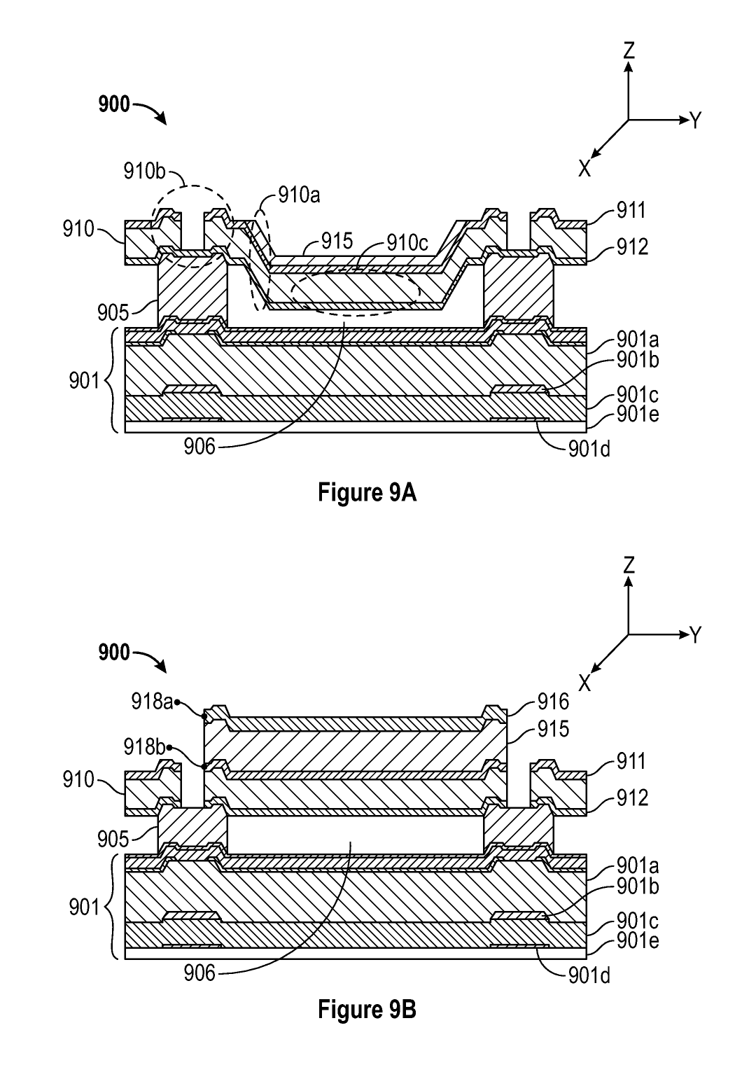

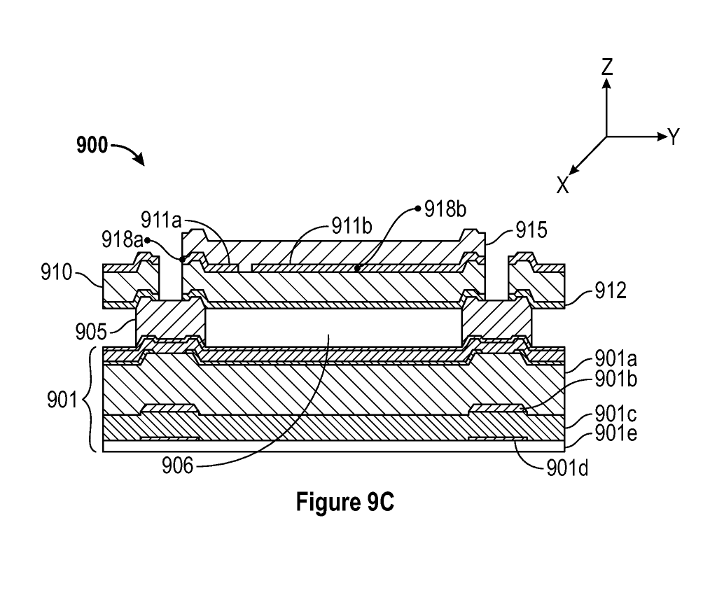

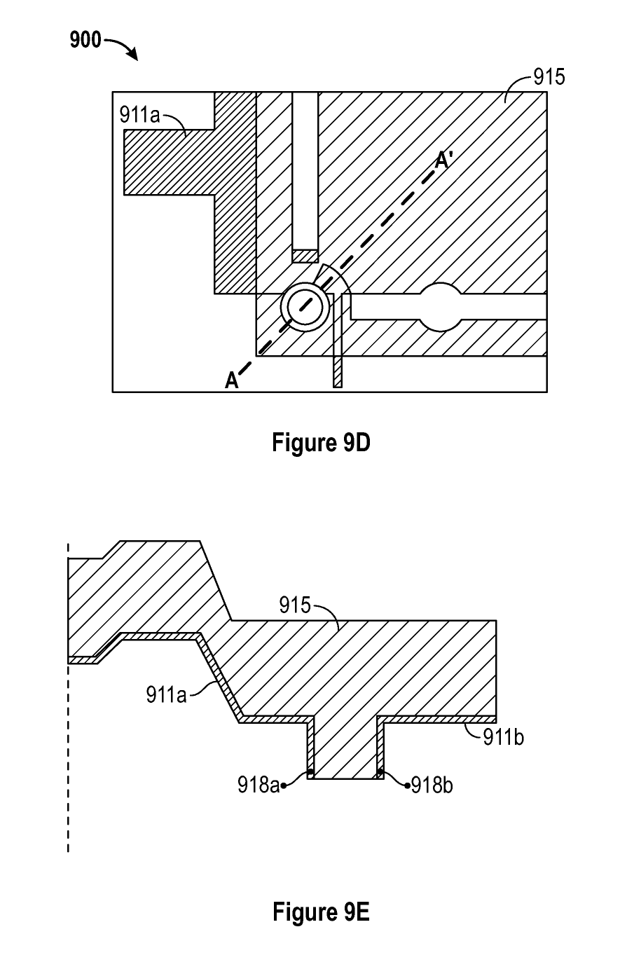

FIGS. 9A-9C show various implementations of an electromechanical systems device that includes a plurality of layers and a piezo-electric layer. The electromechanical systems device 900 includes a stack 901 including a plurality of layers 901a, 901b, 901c, 901d and 901e, a movable layer 910 disposed over the stack 901 and a piezo-electric layer 915 disposed over the movable layer 910. As one having ordinary skill in the art will readily understand, the term “over” as used herein is in a relational context, that is, it is used to indicate a relative position between two structures and not an absolute position. Also, “over” may be used to indicate a structure that is illustrated above another structure in a corresponding drawing that is oriented for normal viewing. The movable layer 910 is supported over the stack 901 by posts 905 such that the movable layer 910 is separated from the stack 901 by a gap 906. The electromechanical systems device 900 illustrated in FIGS. 9A-9C can include one or more implementations of an IMOD that operates in accordance with the principles set forth above. In such implementations, the stack 901 can be similar to the optical stack 16, the movable layer 910 can be similar to the movable reflective layer 14 and the posts can include, but are not limited to, such structure as is illustrated in FIGS. 6A-6E. In various implementations, the stack 901 can include one or more at least partially reflective and at least partially transmissive layers, one or more black mask layers and one or more dielectric layers. The movable layer 910 includes a first electrode 912 proximal to the stack 901 and a second electrode 911 opposite the first electrode 912. The movable layer 910 includes a deformable region 910a such that at least a portion of the movable layer 910 can be moved or actuated through the gap 906 by an actuating force (for example, an electrostatic force generated by a potential difference applied across the first electrode 912 or the second electrode 911 and the optical stack 901). The movable layer 910 further includes a non-deformable region 910b that is configured to be stationary (or non-deformable). For example, the portions of the movable layer 910 that are adjacent to the posts 905 can remain stationary when the portion of the movable layer 910 that is an optically active region 910c moves in the presence of an actuating force.

The piezo-electric layer 915 is disposed over at least a portion of the deformable region of the movable layer 910. In some implementations, the piezo-electric layer 915 is disposed such that it overlaps with most of the deformable region of the movable layer 910. In various implementations, the piezo-electric layer 915 includes one or more piezo-electric material such as, for example, Aluminum nitride (AlN), Zinc oxide (ZnO) or low temperature lead zirconate titanate (PZT). The piezo-electric layer 915 can include materials that can be integrated with electromechanical systems device/integrated circuit fabrication process. In various implementations, the piezo-electric layer 915 can have a thickness between approximately 100 nm and 1000 nm. The thickness of the piezo-electric layer can depend on the material from which it is formed. For example, if the piezo-electric layer 915 includes AlN, the thickness of the piezo-electric layer 915 can be a few hundred nanometers. Although, in the implementations illustrated in FIGS. 9A-9C, the piezo-electric layer 915 is depicted as being disposed over the movable layer 910, a person having ordinary skill in the art would realize that the piezo-electric layer 915 can be disposed under at least a portion of the deformable region of the movable layer 910 such that the piezo-electric layer 915 is disposed between the stack 901 and the movable layer 915. In various implementations, an insulating layer (for example, an oxide layer) can be disposed between the piezo-electric layer 915 and the movable layer 910.

In various implementations, including the implementation depicted in FIG. 9B, a third electrode 916 can be disposed over the piezo-electric layer 915 such that the piezo-electric layer 915 is sandwiched between the second electrode 911 and the third electrode 916. Lead wires, 918a and 918b are connected to the electrodes 916 and 911. Reverse piezo-electric effect can be induced in the piezo-electric layer 915 by applying a potential difference across the lead wires 918a and 918b which generates an electric field along a direction that is orthogonal to a plane of the piezo-electric layer 915 and causes a mechanical stress or strain in the piezo-electric layer 915. In various implementations, conducting traces maybe formed on the substrate which supports the device 900 or on the optical stack 901 or some other portion of the device 900. These conducting traces are electrically connected to the electrodes 911 and 916 such that reverse piezo-electric effect can be induced in the piezo-electric layer 915 by applying a potential difference to the conducting traces or by connecting the conducting traces to the ground.

In some implementations, as depicted in FIG. 9C, the second electrode 911 can be deposited or patterned as two separate electrodes 911a and 911b. The electrodes 911a and 911b can be electrically insulated from each other. The piezo-electric layer 915 is disposed over the two separate electrodes 911a and 911b such that a portion of the piezo-electric layer 915 extends between the two separate electrodes 911a and 911b. The lead wire 918a is connected to the electrode 911a and the lead wire 918b is connected to the electrode 911b. By applying a potential difference across the lead wires 918a and 918b, an electric field is generated across the piezo-electric layer 915 to induce reverse piezo-electric effect and cause a mechanical stress or strain in the piezo-electric layer 915. In such implementations, the electric field generated is along a direction that is parallel (or contained in) a plane of the piezo-electric layer 915.

FIG. 9D illustrates a top-view of the implementation of an electromechanical systems device including a piezo-electric layer 915 depicted in FIG. 9C. FIG. 9E is an enlarged view of the piezo-electric layer 915 illustrated in FIG. 9C. The cross-sectional side view depicts the piezo-electric layer 915, the electrodes 911a and 911b, and lead wires 918a and 918b of the implementation illustrated in FIG. 9C. The cross-section side-view is along the axis A-A′ depicted in FIG. 9D. FIG. 9E depicts the piezo-electric layer 915 in the un-deformed state.

The piezo-electric layer 915 can be deposited over the movable layer 910 by using methods including, but not limited to, In PVD, PECVD, thermal CVD or spin-coating. The piezo-electric layer 915 can be deposited over the movable layer 910 during fabrication of the electromechanical systems device. For example, in implementations of electromechanical systems including an IMOD, the piezo-electric layer 915 can be deposited over the movable reflective layer after block 88 of the process 80 (FIG. 7) described above but prior to forming the cavity (for example, by removing the sacrificial layer) in block 90 of the process 80. In various implementations of manufacturing an IMOD, a metallic layer (for example, a layer of aluminum copper (AlCu)) can be disposed over the movable reflective layer to provide mechanical and electrical balance to the IMOD. This metallic layer is referred to as “top metal” or “cap metal.” In such implementations, the piezo-electric layer 915 can be disposed over the top metal or the cap metal. The top metal or the cap metal can function similar to the electrode layer 911 disclosed above. To induce piezo-electric effect, another conductor which functions similar to electrode layer 916 can be disposed over the piezo-electric layer 915. Alternately, in some implementations, the top metal or the cap metal can be patterned as two separate electrodes, similar to electrodes 911a and 911b. The piezo-electric layer 915 can be deposited over the top metal or the cap metal that is patterned as two separate electrodes. In various implementations, the top metal or the cap metal can include the piezo-electric layer 915. In some implementations, the movable layer 910 can include a piezo-electric material in which case, the movable layer 910 functions as the piezo-electric layer 915.

The piezo-electric layer 915 can accumulate electrical charges in response to a mechanical deformation. This phenomenon is referred to as direct piezo-electric effect. Conversely, the piezo-electric layer 915 can exhibit mechanical deformation in response to an applied Z-electric field. This phenomenon is referred to as reverse piezo-electric effect. Mathematically, piezo-electric effect can be described by Equation (1):

T_{λ}=σ_{λv}·Sᵥ+e_{iλ}·Eᵢ (1)

In Equation (1) above, T_{λ} is the stress tensor of the piezo-electric layer 915. In various implementations, the stress tensor T_{λ} can be related to the restoration force produced by the piezo-electric layer 915. The term Sᵥ in Equation (1) is the strain tensor of the piezo-electric layer 915. In various implementations, the strain tensor Sᵥ can be related to deformation produced in the piezo-electric layer 915. The term σ_{λv} is the stiffness tensor of the piezo-electric layer 915 and the term e_{iλ} is the piezo-electric coefficient tensor of the piezo-electric layer 915. The term Eᵢ refers to the electric field generated in the piezo-electric layer 915.

The piezo-electric coefficient tensor e_{iλ} of the piezo-electric layer 915 is a property of the material of the piezo-electric layer 915 and is different for different materials. For example, for aluminum nitride (AlN) the piezo-electric coefficient tensor e_{iλ} is given by Equation (2):

$${e}_{i λ} = ( \begin{matrix}0 & 0 & 0 & 0 & - 0.48 & 0 \\ 0 & 0 & 0 & … - 0.48 & 0 & 0 \\ - 0.58 & - 0.58 & 1.55 & 0 & 0 & 0\end{matrix} ) \frac{C}{{m}^{2}} \qquad ( 2 )$$

Non-zero values for the elements in the third row and first column, e₃₁, and the third row and second column, e₃₂, of the tensor e_{iλ} in Equation (2) indicates that if an electric field having a component along the vertical or z-direction (for example, along a direction perpendicular to the plane of the piezo-electric layer 915) is applied, the piezo-electric layer 915 can respond with a structural deformation (for example by expanding, contracting and/or rotating) in the plane of the piezo-electric layer 915 (for example, along the X and Y directions). Non-zero value for the element in the third row and third column, e₃₃, of the tensor e_{iλ} in Equation (2) indicates that the piezo-electric layer 915 can also deform (for example, by expanding, contracting and/or rotating) along a vertical direction (for example, along the Z direction) in response to an applied electric field.

Direct and reverse piezo-electric effect induced in the piezo-electric layer 915 can be used to mitigate or reduce release related or in-use stiction in the electromechanical systems device 900 as discussed below. To reduce or mitigate release related stiction, the piezo-electric layer 915 is deposited over the movable layer 910 prior to the removal of the sacrificial layer and the electromechanical systems device 900 is in the unreleased state as discussed above. The movable layer 910 is not free to move in the unreleased state of the electromechanical systems device. When the sacrificial layer is removed, the electromechanical systems device 900 is in the released state and the movable layer 910 becomes free to move. Upon removal of the sacrificial layer (“release”), the movable layer 910 can deform due to mechanical stresses in the material, which in turn deforms the piezo-electric layer 915. Deformation of the piezo-electric layer 915 during release or during operation of the electromechanical systems device 900 can cause charges to accumulate on the piezo-electric layer 915 due to a piezo-electric effect, which in turn can cause a voltage to be developed across the piezo-electric layer 915.

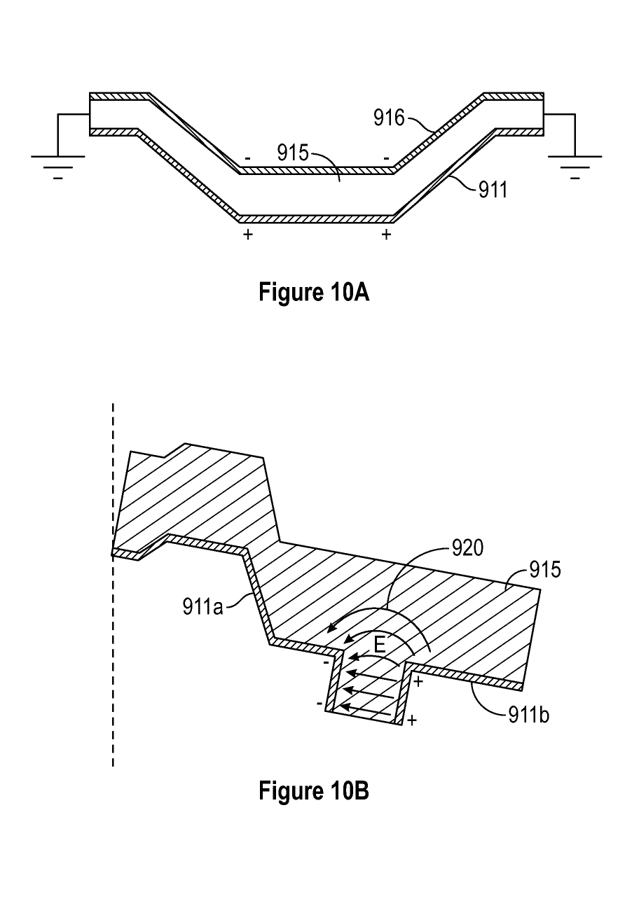

FIG. 10A shows the charges accumulated in an example implementation of a piezo-electric layer 915 sandwiched between two electrodes 911 and 916 as depicted in FIG. 9B. The piezo-electric layer 915 has a bottom surface that is proximal to the stack 901 and a top surface opposite the bottom surface. In implementations, where the piezo-electric layer 915 is disposed over the movable layer 910, the bottom surface is adjacent the movable layer 910. As illustrated in FIG. 10A, when the piezo-electric layer 915 is deformed, an amount of charge having a first polarity accumulates on the top surface of the piezo-electric layer 915 adjacent the electrode 916 and an equal amount of charge having a second polarity opposite the first polarity accumulates on the bottom surface of the piezo-electric layer 915 adjacent the electrode 911. A potential difference may develop across a top surface and a bottom surface of the piezo-electric layer 915 due to the accumulated charges when the piezo-electric layer 915 (or the movable layer 910) is deformed.

FIG. 10B shows the charges accumulated in an example implementation of a piezo-electric layer 915 disposed over two electrodes 911a and 911b as depicted in FIG. 9C. As illustrated in FIG. 10B, when the movable layer 910 is actuated, the piezo-electric layer 915 is deformed and consequently an amount of charge having a first polarity accumulates on a first side of the piezo-electric layer 915 adjacent the electrode 911a and an equal amount of charge having a second polarity opposite the first polarity accumulates on a second side of the piezo-electric layer 915 adjacent the electrode 911b. The accumulation of charges on the two sides of the piezo-electric layer 910 generates an electric field 920 having a field strength E in the plane of the piezo-electric layer 915.

The deformed piezo-electric layer 915 can be returned to the un-deformed state by the application of a voltage that is equal in magnitude and opposite in polarity to the voltage developed across the deformed edges of the piezo-electric layer 915. In various implementations, the magnitude of the applied voltage can be between approximately 0V and 40V. In various implementations, the piezo-electric layer 915 can be returned to the un-deformed state by connecting the deformed edges to a ground as shown in FIG. 10A. In some implementations, the electrodes 916 and 911 (FIG. 10A) or electrodes 911a and 911b (FIG. 10B) can be shorted to remove the charge differential and return the piezo-electric layer 915 to an un-deformed state. In some implementations, a voltage source having a polarity opposite the polarity of the potential difference generated in the piezo-electric layer 915 can be connected between the electrodes 916 and 911 (FIG. 10A) or electrodes 911a and 911b (FIG. 10B) to return the piezo-electric layer 915 to the un-deformed state. When the piezo-electric layer 915 is returned to the un-deformed state, the movable layer 910 can also be simultaneously returned to the un-deformed state using at least in part force from the mechanically coupled piezo-electric layer 915. In this manner, the piezo-electric layer 915 can reduce or mitigate release related stiction.

During the operation of such electromechanical systems, initially, the movable layer 910 is in the un-deformed state and in a first position that is farther from the stack 901. When an actuating force (for example, a potential difference applied between the movable layer 901 and the stack 901) is provided to the movable layer 910, the movable layer 910 is moved to a second position that is closer to the stack 901. In the second position the movable layer 910 is in the deformed state. When the actuating force provided to the movable layer 910 is removed, the movable layer 910 returns to the first position (and to the un-deformed state) due to the mechanical restorative force provided by the non-deformable regions of the movable layer 910. When the movable layer 910 is deformed due to actuation, the piezo-electric layer 915 is also deformed and can develop a potential difference across its deformed edges due to the accumulation of charges on the two sides of the piezo-electric layer 915 as discussed above. In some instances, over time the movable layer 910 may not fully return to the un-deformed state due to environmental reasons or due to a reduction in the restorative force provided by the non-deformable regions of the movable layer 910 (for example, caused by material fatigue), and this can result in the movable layer 910 exhibiting effects of stiction. When the movable layer 910 does not fully return to the un-deformed state, the piezo-electric layer 915 may also not return to the un-deformed state. To mitigate or reduce in-use stiction and to return the movable layer 910 to the un-deformed state, the piezo-electric layer 915 may be returned to the un-deformed state by reverse piezo-electric effect. For example, by periodically applying a potential difference across the piezo-electric layer 915, for example, by applying a potential difference between the lead wires 918a and 918b of FIGS. 9B and 9C, an additional restorative mechanical force is provided to the piezo-electric layer 915 (and consequently to the movable layer 910) to return the piezo-electric layer 915 and the movable layer 910 to the un-deformed state. Alternately, the lead wires 918a and 918b of FIGS. 9B and 9C can be connected to each other or shorted or connected to the ground to provide an additional restorative mechanical force to return the piezo-electric layer 915 and the movable layer 910 to the un-deformed state. When the lead wires 918a and 918b are shorted or connected to the ground, the charges accumulated on the two sides of the piezo-electric layer 915 are removed which in turn generates the additional restorative mechanical force due to reverse piezo-electric effect. The amount of the additional restorative mechanical force can depend on the magnitude and the polarity of the potential difference that is applied across the edges of the piezo-electric layer 915. In this manner the piezo-electric layer 915 can mitigate or reduce in-use stiction.

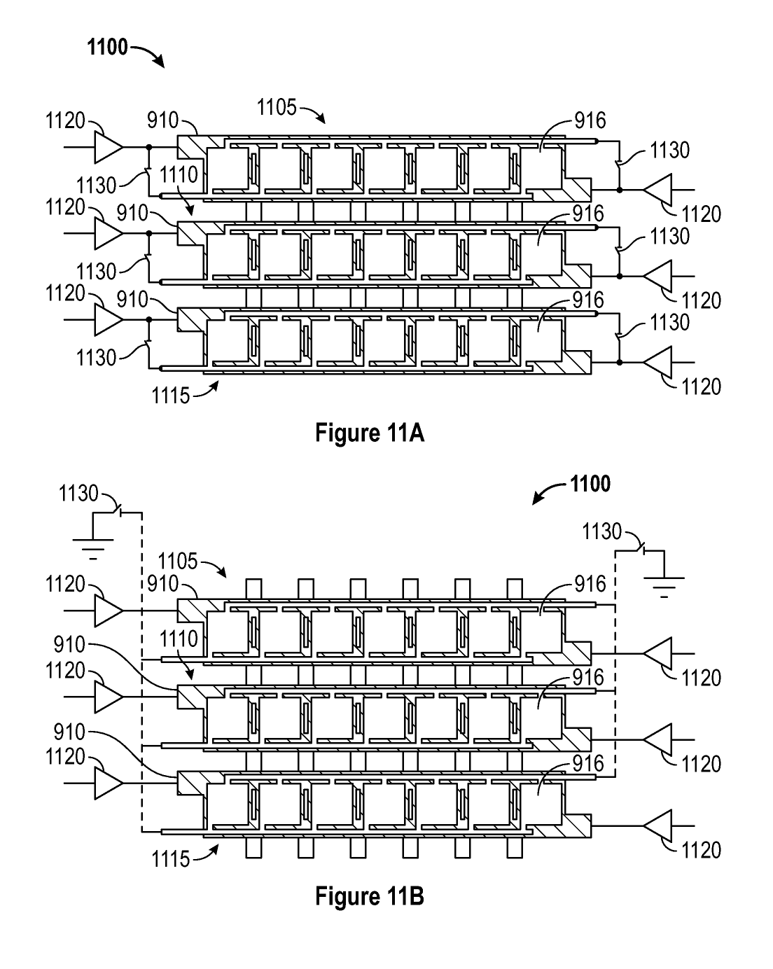

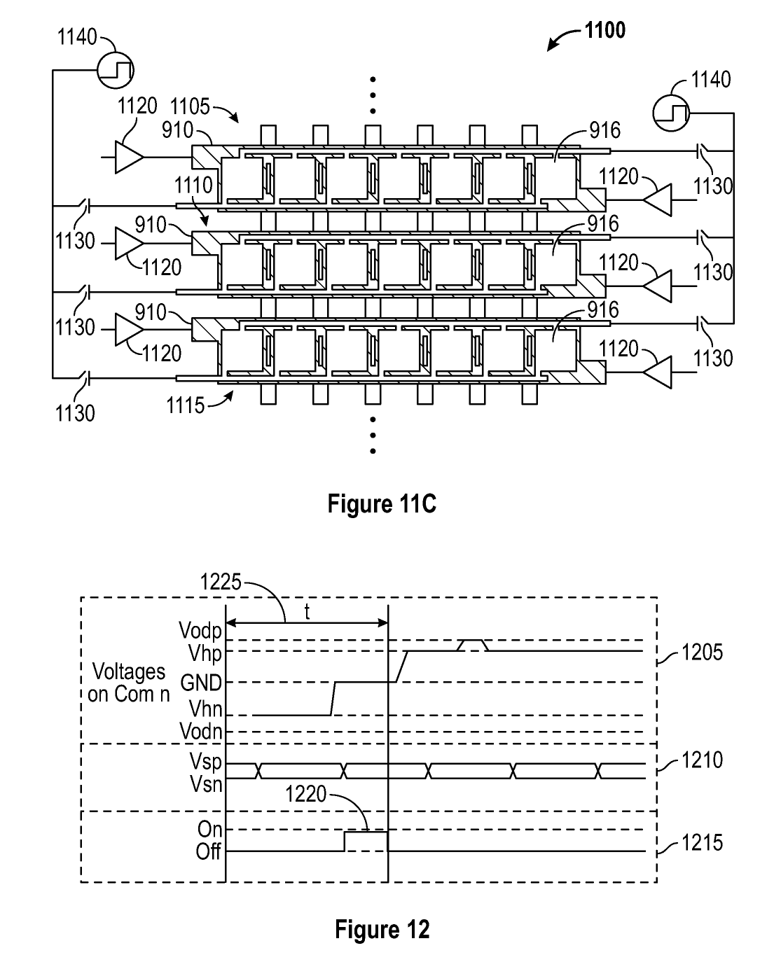

FIGS. 11A-11C is a schematic top view of an example of an array of electromechanical systems devices each including a piezo-electric layer and including different methods of providing an additional restorative mechanical force to return the piezo-electric layer to the un-deformed state. The array 1100 depicted in FIGS. 11A-11C includes multiple electromechanical systems devices 900 depicted in FIGS. 9A-9C arranged in a plurality of rows 1105, 1110 and 1115. The multiple electromechanical systems devices 900 in each of the rows 1105, 1110 and 1115 are driven or actuated by column drivers 1120. In example illustrated in FIGS. 11A-11C, the multiple electromechanical systems devices 900 in each row 1105, 1110 and 1115 are connected to two column drivers 1120. In other implementations, the multiple electromechanical systems devices 900 in each of the rows 1105, 1110 and 1115 can be connected to only one column driver 1120. Each of the electromechanical systems devices 900 in row 1105 is configured to provide a first optical response (for example, to display a first color) when the movable layer 910 is actuated. Each of the electromechanical systems devices 900 in row 1110 is configured to provide a second optical response (for example, to display a second color) when the movable layer 910 is actuated. Each of the electromechanical systems devices 900 in row 1115 is configured to provide a third optical response (for example, to display a third color) when the movable layer 910 is actuated. Although only three rows of electromechanical systems devices 900 are shown in FIGS. 11A-11C, a person having ordinary skill in the art would understand that the number of rows in the array can be greater than three. Each of the FIGS. 11A-11C illustrates a method of returning the piezo-electric layer 915 to its un-deformed state to provide an additional mechanical restorative force to the movable layer 910.

FIG. 11A illustrates a de-stiction switch 1130 connected between the electrodes disposed adjacent the deformed edges of the piezo-electric layer 915 to periodically short the electrodes and remove the charges that accumulate across the piezo-electric layer 915 due to deformation of the piezo-electric layer 915. For example, the de-stiction switch 1130 can be connected between the electrodes 916 and 911 or the electrodes 911a and 911b of each of the electromechanical systems devices 900 in the array 1100. FIG. 11B illustrates connecting the electrodes disposed adjacent the deformed edges of the piezo-electric layer 915 to an electrical ground via the de-stiction switch 1130. By periodically closing the de-stiction switch 1130, the electrodes 916 and 911 or the electrodes 911a and 911b (as illustrated in FIGS. 10A and 10B, respectively) of each of the electromechanical systems devices 900 in the array 1100 can be connected to the electrical ground to remove the charges that accumulate across the piezo-electric layer 915 due to deformation of the piezo-electric layer 915. FIG. 11C illustrates a voltage source 1140 connected to the electrodes 916 and 911 or 911a and 911b via a de-stiction switch 1130 to provide a de-stiction voltage pulse having a polarity opposite the polarity of the potential difference generated across the piezo-electric layer 915 to remove the charges that accumulate across the piezo-electric layer 915 due to deformation of the piezo-electric layer 915.

FIG. 12 shows an example of a timing diagram for voltages applied to the example depicted in FIG. 11C. The diagram 1205 and 1210 illustrate the profile of the voltage applied across the stack 901 and the movable layer 910 to actuate the movable layer 910 of each of the electromechanical systems devices 900 in the array to produce a desired optical response. For example, the diagram 1205 can correspond to the common voltage or signal that is applied to the devices 900 in a row of the array as discussed above and the diagram 1210 can correspond to the segment voltage that is applied to the devices 900 in a column of the array as discussed above. The diagram 1215 illustrates the profile of the de-stiction voltage provided by the voltage source 1140. In the illustrated example, the common voltage or signal indicated by diagram 1205 makes a transition from a hold state with negative polarity (Vhn), to a ground state. In various implementations, driving all the devices in a row to the ground state can be referred to as a reset cycle in which all the devices in a row are reset. The transition from the hold state to the ground state can occur over a transition time, ‘t’, indicated by reference numeral 1225. During the transition time, ‘t,’ one or more de-stiction pulses or an AC signal 1220 can be applied to electrodes of the piezo-electric layer 915 for each of the devices 900 in the row as indicated by the diagram 1215. The one or more de-stiction pulses or the AC signal 1220 can be useful in resetting the devices 900 in a row by providing an additional restorative force to return the movable electrodes of the devices 900 in the row to the undeformed state. After completion of the reset cycle, the common voltage or signal transitions to a positive hold voltage (Vhp), and subsequently to a write state (Vodp) as illustrated in diagram 1205. The frame of display data can be written to the devices in the row during the write state. After the frame of display data is written, common voltage or signal transitions down to a positive hold voltage (Vhp) where the state of pixels will be preserved till the next cycle. The one or more de-stiction pulses or AC signal can be periodically applied across the piezo-electric layer 915. In various implementations, the de-stiction pulse 1220 can be a global event provided at the beginning and/or end of a frame. In some implementations, the de-stiction switches 1130 connected to the electromechanical systems devices 900 in the rows 1105, 1110 and 1115 can be individually toggled to provide the de-stiction pulse 1220 to the devices 900 in the middle of a frame. In some implementations, the de-stiction pulse 1220 can be applied to the devices 900 in the array 1100 periodically, such as, for example, on a weekly or monthly basis. The magnitude and the polarity of the de-stiction pulse 1220 can be selected based on the magnitude and polarity of the charges developed in the piezo-electric layer 915. In various implementations, the voltage source 1140 provides an AC voltage signal as the de-stiction pulse 1220. The magnitude and the frequency of the de-stiction pulse 1220 can be selected to match the resonance frequency of the piezo-electric layer 915 or the movable layer 910 to excite resonance in the piezo-electric layer 915 or the movable layer 910 and provide enhanced mechanical restorative force. In various implementations, the voltage source 1140 can be adapted to provide a voltage between about 0V and about 40V.

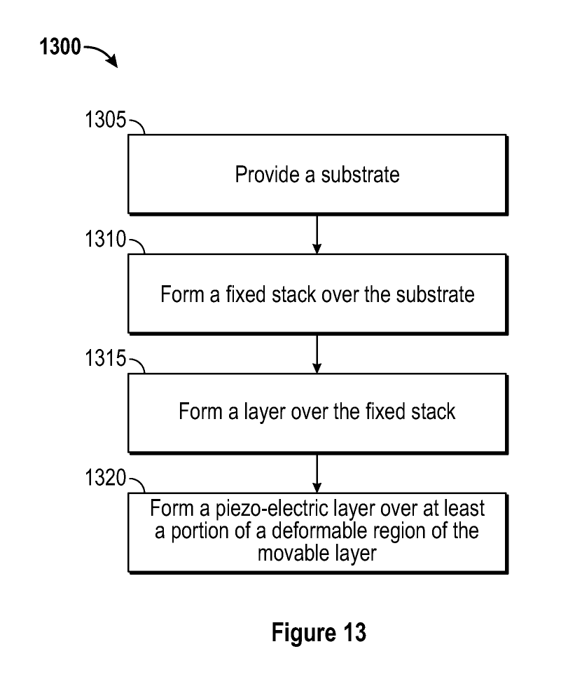

FIG. 13 is a flowchart showing an example of a method of manufacturing an implementation of an electromechanical systems device including a piezo-electric layer. The method 1300 includes providing a substrate (for example, substrate 20) as illustrated in block 1305. The method 1300 further includes forming a fixed stack of materials (for example, the stack 901 of FIGS. 9A-9C or the optical stack 16 of FIG. 1) on the substrate. In some implementations, the fixed stack of materials can be formed on the substrate by using thin film processing methods, such as, for example, physical vapor deposition (PVD, e.g., sputtering), plasma-enhanced chemical vapor deposition (PECVD), thermal chemical vapor deposition (thermal CVD), or spin-coating. In various implementations, the fixed stack of materials can be formed on the substrate by patterning or lithography methods. The method 1300 then proceeds to forming a movable layer as shown in block 1315 (for example, movable layer 910 or the movable reflective layer 14) over the fixed stack. The movable layer can be deposited over the fixed stack using deposition, patterning, lithography or etching techniques described above. The method 1300 then proceeds to forming a piezo-electric layer (for example, piezo-electric layer 915) at least over a deformable portion of the movable layer as shown in block 1320. The movable layer and/or the piezo-electric layer can be deposited over the fixed stack using deposition, patterning, lithography or etching techniques described above.

Various implementations of the method can include forming a top layer or a metal cap layer on the movable layer prior to forming the piezo-electric layer. In various implementations, the top layer or the metal cap layer can be patterned have a first portion and a second portion, the first and second portions being separated from each other by an opening. The piezo-electric layer is formed such that a portion of the piezo-electric layer extends into the opening. Various implementations of the method can include forming an electrode layer over the piezo-electric layer. The electrode layer and the top layer or the metal cap layer can be formed by depositing an electrical conducting material (for example, metal) over the piezo-electric layer or the movable layer.

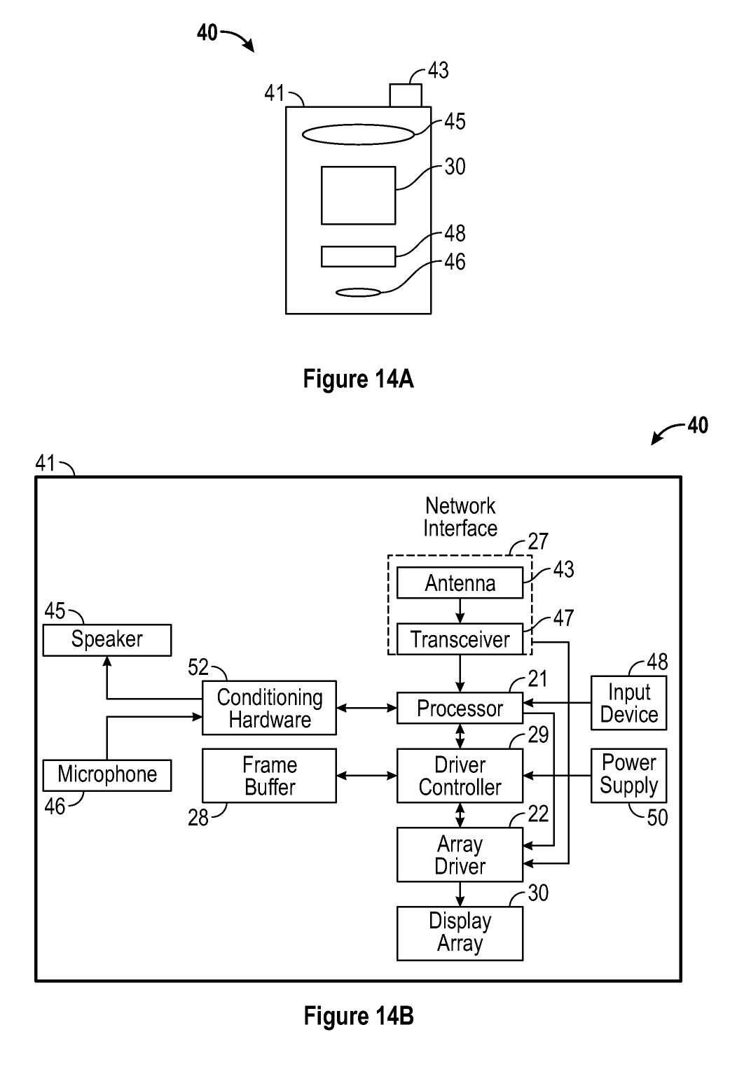

FIGS. 14A and 14B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. In various implementations, the display 30 can include a plurality of display elements, each display element including at least one electromechanical systems device having a piezo-electric layer as described above. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels. In various implementations, the array driver 22 can be configured to provide a de-stiction pulse from the voltage source 1140 described above and/or activate the de-stiction switches 1130 described above periodically (for example, in between frames or a few times every hour, or a few times every week) to provide an additional mechanical restorative force to the plurality of display elements.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (for example, a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems device, comprising:
an optical stack;
a movable layer disposed over the optical stack and separated from the optical stack by a gap, the movable layer including a deformable region that deforms when the movable layer is actuated, the movable layer further including an optically active region that is positioned substantially flat when the movable layer is actuated, the movable layer being configured to actuate between at least a first position that is farther from the optical stack and a second position that is closer to the optical stack by the application of a first voltage across the optical stack and the movable layer, the deformable region of the movable layer being in an un-deformed state in the first position and in a deformed state in the second position; and
a piezo-electric layer disposed over at least a portion of the deformable region of the movable layer, the piezoelectric layer configured to provide a restorative force to restore the movable layer from the second position to the first position upon application of a second voltage across a first electrical contact and a second electrical contact of the piezoelectric layer.

2. The electromechanical systems device of claim 1, wherein the movable layer includes a first electrode layer that includes the first electrical contact.

3. The electromechanical systems device of claim 2, further comprising a second electrode layer that includes the second electrical contact, wherein the piezo-electric layer is disposed between the movable layer and the second electrode.

4. The electromechanical systems device of claim 2, wherein the first electrode layer includes a first portion including the first electrode contact and further includes a second portion that includes the second electrical contact, and wherein the piezo-electric layer extends between the first and second electrical contacts of the first electrode layer.

5. The electromechanical systems device of claim 3, wherein the second voltage is applied across the first and second electrode layers.

6. The electromechanical systems device of claim 4, wherein the second voltage is applied across the first and second electrical contacts of the first electrode layer.

7. The electromechanical systems device of claim 1, wherein the piezo-electric layer is configured such that a magnitude of the restorative force depends at least in part on the magnitude of the second voltage.

8. The electromechanical systems device of claim 1, wherein the piezo-electric layer is configured such that a magnitude of the restorative force depends at least in part on the polarity of the second voltage.

9. The electromechanical device of claim 1, wherein the second voltage is between 0V and 40V.

10. The electromechanical device of claim 1, wherein the second voltage is an alternating current (AC) signal.

11. The electromechanical device of claim 10, wherein the movable layer has a resonance frequency and a frequency of the AC signal is proportional to the resonance frequency.

12. The electromechanical device of claim 1, wherein the first electrical contact is connected to an electrical ground via a first electrical switch and the second electrical contact is connected to the electrical ground via a second electrical switch.

13. The electromechanical device of claim 15, wherein the first and the second electrical switches are periodically toggled to provide the restorative force.

14. The electromechanical device of claim 1, wherein the first and the second electrical contacts are connected together via an electrical switch.

15. The electromechanical device of claim 14, wherein the electrical switch is periodically toggled to short the first and second electrical contacts to provide the restorative force.

16. The electromechanical systems device of claim 1, wherein the movable layer includes a partially reflective layer.

17. The electromechanical systems device of claim 1, wherein the movable layer, the optical stack and the gap form an interferometric modulator.

18. The electromechanical systems device of claim 1, wherein the device is a reflective display element.

19. The electromechanical systems device of claim 1, further comprising at least one support structure configured to support the movable layer over the optical stack, wherein a non-deformable region of the movable layer is disposed over the support structure.

20. The electromechanical systems device of claim 1, further comprising:
a display;
a processor that is configured to communicate with the display, the processor being configured to process image data; and
a memory device that is configured to communicate with the processor.

21. The electromechanical systems device of claim 20, further comprising:
a driver circuit configured to send at least one signal to the display.

22. The electromechanical systems device of claim 21, further comprising a controller configured to send at least a portion of the image data to the driver circuit.

23. The electromechanical systems device of claim 22, further comprising an image source module configured to send the image data to the processor, wherein the image source module includes at least one of a receiver, transceiver, and transmitter.

24. The electromechanical systems device of claim 20, further comprising an input device configured to receive input data and to communicate the input data to the processor.

25. An electromechanical systems device comprising:
means for partially transmitting light;
movable means for reflecting light, the movable light reflecting means disposed over the partially light transmitting means and separated from the partially light transmitting means by a gap, the movable light reflecting means including a deformable region that deforms when the movable light reflecting means is actuated, the movable light reflecting means including an optically active region that is substantially flat when the movable light reflecting means is actuated, the movable light reflecting means being configured to actuate between at least a first position that is farther from the partially light transmitting means and a second position that is closer to the partially light transmitting means by the application of a first voltage between the partially light transmitting means and the movable reflecting means, the deformable region of the movable reflecting means being in an un-deformed state in the first position and in a deformed state in the second position; and
means for producing a mechanical strain disposed over at least a part of the deformable region of the movable light reflecting means, the mechanical strain producing means configured to generate a mechanical restorative force to restore the movable light reflecting means from the second position to the first position upon application of a second voltage across a first electrical contact and a second electrical contact of the mechanical strain producing means.

26. The device of claim 25, wherein the means for partially transmitting light includes an optical stack having a partially transmissive layer, and the movable means for reflecting light includes a movable reflecting layer, and the mechanical strain producing means includes a piezo-electric layer.

27. The device of claim 25, wherein the movable means for reflecting light includes a first electrode layer that includes the first electrical contact.

28. The electromechanical systems device of claim 27, further comprising a second electrode layer, wherein the mechanical strain producing means is disposed between the movable light reflecting means and the second electrode.

29. The electromechanical systems device of claim 27, wherein the first electrode layer includes a first portion including the first electrical contact and a second portion including the second electrical contact, and wherein the mechanical strain producing means extends between the first and second portions of the first electrode layer.

30. A method of manufacturing an electromechanical systems device, the method comprising:
providing a substrate;
forming a stack over the substrate, the stack being partially transmissive to light;
forming a movable layer over the stack, the movable layer separated from the optical stack by a gap, wherein forming the movable layer includes forming a deformable region that deforms when the movable layer is actuated and forming an optically active region that is positioned substantially flat when the movable layer is actuated, wherein the movable layer is configured to actuate between at least a first position that is farther from the stack and a second position that is closer to the stack by the application of a first voltage between the stack and the movable layer, the deformable region of the movable layer being in an un-deformed state in the first position and in a deformed state in the second position; and
forming a piezo-electric layer over at least part of the deformable region of the movable layer, the piezoelectric layer being configured to provide a restorative mechanical force to restore the movable layer from the second position to the first position upon application of a second voltage across a first electrical contact and a second electrical contact of the piezoelectric layer.

31. The method of claim 30, wherein forming the movable layer includes forming a first electrode that includes the first electrical contact.

32. The method of claim 31, wherein forming the first electrode includes patterning the first electrode to have a first portion and a second portion, the first and second portions being separated from each other by an opening, and wherein the piezo-electric layer is formed such that a portion of the piezo-electric layer extends into the opening.

33. The method of claim 31, further comprising forming a second electrode layer over the piezo-electric layer.
